(19) United States
(12) Patent Application Publication
(10) Pub. No.: US 2026/0219925 A1
(43) Pub. Date: Jul. 30, 2026

(54) DIGITAL APPLICATION PLATFORM ARCHITECTURE

(71) Applicant: Siemens Aktiengesellschaft, München (DE)

(72) Inventors: Constantinos Christou Pantelides, London (GB); Frances Pereira, London (GB); Penelope Stanger, London (GB)

(21) Appl. No.: 19/144,585

(22) PCT Filed: Jan. 5, 2024
(86) PCT No.: PCT/EP2024/050240

§ 371 Date: Jun. 30, 2025

(30) Foreign Application Priority Data
Jan. 10, 2023 (GB) 2300342.9

(51) Int. Cl. G06F 9/48

(52) U.S. Cl. CPC G06F 9/4881

(57) ABSTRACT

A general digital application platform architecture for implementing a class of digital application within an industrial plant operational decision support system is provided. The platform supports a set of computational modules adapted to perform model-based computations relating to the plant; bidirectional communication with one or more external data servers; validation of data received from such external data servers and of results supplied to them; and a digital application metafile containing softcoded data governing the scheduling of, and data exchange between, the computational modules. The set of computational modules and the digital application metafile are specific to the class of digital application being implemented.

### CROSS REFERENCE TO RELATED APPLICATIONS

This application is a national stage of PCT Application No. PCT/EP2024/050240, having a filing date of Jan. 5, 2024, which claims priority to GB Application No. 2300342.9, having a filing date of Jan. 10, 2023, the entire contents both of which are hereby incorporated by reference.

### FIELD OF TECHNOLOGY

The following relates to a digital application platform architecture within an industrial plant operational decision support and/or control/automation system, and a method of generating a digital application metafile for use in the digital application platform architecture.

### BACKGROUND

Software-based techniques for modeling and assessing industrial plant performance have been used for many years in a number of industrial sectors, such as oil and gas, chemicals, petrochemicals, pharmaceuticals, food and beverage, agrochemicals, minerals and mining, to name but a few. Such digital design and operations applications may be based on a software platform or architecture that hosts both modeling and process environments. These environments may then enable various applications for digital research and development activities, digital engineering and design, and digital operations. One example of such a system is the gPROMS process modeling technology available from Siemens PSE (www.psenterprise.com), where a single platform is used as the basis for modeling and operational environments, enabling a wide range of industries to create so-called digital twins of industrial processes. This then generates value through better design and more efficient operations. A digital twin is a virtual representation of a physical system, created using sensor data from the twinned physical system, and CAx software that simulates the twinned system and processes the sensor data to recreate the behavior of the twinned physical system. The underlying models may be based on equations derived from either physical principles and other prior knowledge, or from plant data, or from a combination of both approaches within a hybrid modeling framework. Alternatively, the models may be entirely statistical in nature, based exclusively on current and historical industrial plant data. The digital twin can then be used to explore the twinned physical system, such as investigating issues, performance and condition.

Whilst digital twins are used to mimic the behavior of a system, digital applications are integrated software systems that make use of mathematical models of process systems coupled with industrial plant data to perform well-defined tasks. In other words, the purpose of a digital application is not simply to mimic the behavior of the process but to use models that represent that behavior to perform specific tasks, such as controlling the physical system or optimising its performance in real time.

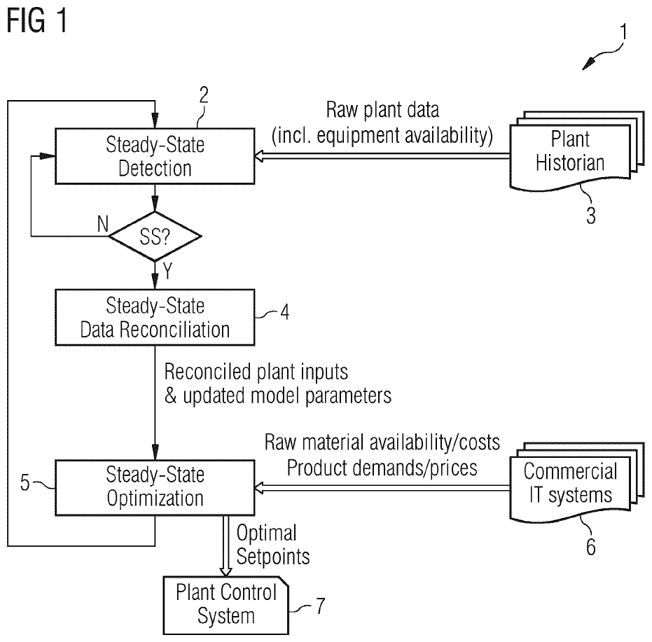

In general, most non-trivial digital applications involve multiple instances of one or more calculations being executed in parallel or sequentially to each other in real time. These calculations may also exchange information with one another as well as undertake the bidirectional exchange of information with external data servers. Such external data servers not only provide the input data to the calculations carried out by the digital applications, but are also sent the results of those calculations. One example of this is illustrated in FIG. 1. FIG. 1 is a schematic representation of a prior art real-time optimization (RTO) digital application for a process. This is a well-established type of digital application. In its conventional form, real-time optimization involves the solution of a steady-state optimization calculation making use of a steady-state model of the process, with the aim of determining optimal operational settings for the control system of an industrial plant implementing the process. As the optimization depends on the current inputs of the industrial plant and the parameters of the underlying model, it is typically preceded by a steady-state data reconciliation calculation that aims to obtain reliable up-to-date values of these quantities using available measurements from sensors and systems within the industrial plant. Moreover, since data reconciliation is performed on a steady-state basis, it is essential to ensure that the industrial plant is approximately at steady-state before using the measurements. FIG. 1 illustrates this schematically, where the digital application for steady-state real-time optimization 1 is shown to comprise a sequence of instances of three computations. Firstly, a steady-state detection computational module 2 uses a statistical analysis of industrial plant data received from an industrial plant historian 3 to determine whether or not the industrial plant is operating in a steady state. If the answer is no, the computational module repeats the steady-state detection procedure after an appropriate time interval. If the answer is yes, a steady-state data reconciliation computational module 4 uses mathematical optimization techniques applied to a mathematical model of the process to produce reconciled industrial plant inputs and updated model parameters. These feed into a steady-state optimization computational module 5, that also uses data such as raw material and energy availability and costs, as well as product demands and prices obtained from commercial IT systems 6 to optimise a further mathematical model. This final optimization determines the optimal setpoints to be output to the plant control system 7. The three computational steps 2, 4 and 5 are executed sequentially in a cycle that runs periodically, for example once per hour.

FIG. 1 illustrates that even ostensibly simple and well-understood digital applications, such as the real-time optimization example, are complex software systems combining model-based calculations with industrial plant data in real time. This complexity is compounded by the need to be able to handle abnormal, but common, situations, such as temporary interruptions in the availability of input data, erroneous input data and failures in model-based calculations. These factors place stringent requirements on the testing and validation required to ensure that the digital applications can operate faultlessly, continuously and with little human intervention in the longer term following successful initial development and deployment.

There is a wide range of existing and potential digital applications that are very different to each other in terms of intended function, underlying calculations and the types of external data servers with which they exchange information. In principle, the complexity of such digital applications can be, and has been previously, addressed by systematic software engineering. However, this comes at a non-negligible cost in terms of financial and time requirements for the development of the large amounts of customized computer code required even for a relatively simple application such as real-time optimization. Combined with the diversity of potentially useful digital applications, this poses a serious impediment to their large-scale development and adoption. This is reflected in the relatively small range of commercially available digital applications, which are currently limited to a few, well-established classes, such as linear Model-Predictive Control (MPC) and real-time optimization.

### SUMMARY

There is therefore a need to be able to design, develop and implement such digital applications simply and easily, and to reduce the complexity associated with this process.

An aspect relates to a general digital application platform architecture for implementing a wide class of digital applications within an industrial plant operational decision support system, comprising: a set of computational modules adapted to perform model-based computations relating to the plant; a scheduler module adapted to orchestrate the execution of the computational modules; a resource manager module adapted to allocate computational resources to enable the execution of the computational modules; a data manager adapted to communicate with external data servers providing plant-related data and plant control; data validation modules adapted to validate data received from the external data servers and to validate results computed by the set of computational modules; and a digital application metafile, accessible by all components of the digital application, containing softcoded data governing the scheduling of the execution of, and the data exchange between, the computational modules; wherein the set of computational modules and the digital application metafile are specific to the class of digital application being implemented; and wherein the softcoded data defines the information relevant to the class of digital application in terms of categories of the variables required in the models used by the computational modules and attributes associated with each category.

By providing softcoded data within the digital application metafile, the need for developing and maintaining customized computer code for any specific class of digital application is removed. This allows the complexity and diversity of all classes of digital applications to be managed flexibly and reliably, delivering high-quality applications in a cost-effective manner.

In an embodiment, the data validation modules comprise: an external data validation module adapted to validate data obtained from the external data servers using criteria softcoded in the digital application metafile; and a results validation module adapted to validate results from each of the computational modules in the set using criteria softcoded in the digital application metafile.

The digital application platform architecture may further comprise an execution monitor module adapted to monitor execution of the digital application in real time and to take appropriate action if it deviates from the expected performance or stops executing in its entirety.

The digital application platform architecture may further comprise an archiver module adapted to maintain a record of the performance of the digital application, including the execution of each instance of each computational module.

In an embodiment, one or more instances of each computational module are executed asynchronously in parallel, the occurrence, time and frequency of execution of such instances being determined based on scheduling rules softcoded in the digital application metafile.

In an embodiment, the data manager is adapted to communicate using a plurality of data exchange protocols.

In an embodiment, communication with each external data server is effected via a data client conforming to a standardized software interface, wherein the data manager and external data servers are configured to implement an industry-standard or proprietary communication protocol.

The digital application platform architecture may further comprise input to the set of computational modules from one or more mathematical models describing the behavior of the industrial plant.

In an embodiment, one or more computational modules within a set perform different types of computation, each making use of a different mathematical model.

In an embodiment, the metadata is stored within the digital application metafile in a structured file format.

Embodiments of the present invention also provide, in a further aspect, a computer-implemented method of generating a digital application metafile for use in the digital application platform architecture outlined above, embodiments of the method comprising the steps of: a) identifying the set of computational modules that are executable by the digital application; b) defining the conditions under which one or multiple instances of a computational module are to be executed based on data received from external data servers and/or generated by the execution of other computational modules; c) defining the categories of variables that the digital application uses to perform computational tasks; d) defining the compatibility rules between variable categories; e) defining the attributes associated with each defined category of variable; f) based on the defined attributes, determining criteria for external data validation, result validation, computing resource allocation and execution scheduling; and g) storing the defined variable categories with their associated attributes, and the criteria for external data validation, result validation, computing resource allocation and execution scheduling as metadata associated with the digital application within the digital application metafile.

In embodiments, the method may further comprise defining industrial plant parameters, data validation consistency rules, rules governing the inter-computational module communication and an execution schedule for the scheduler module; and storing within the digital application metafile.

In an embodiment, the metadata is stored within the digital application metafile in a structured file format.

### BRIEF DESCRIPTION

Some of the embodiments will be described in detail, with references to the following Figures, wherein like designations denote like members, wherein:

FIG. 1 shows a schematic illustration of a prior art approach;

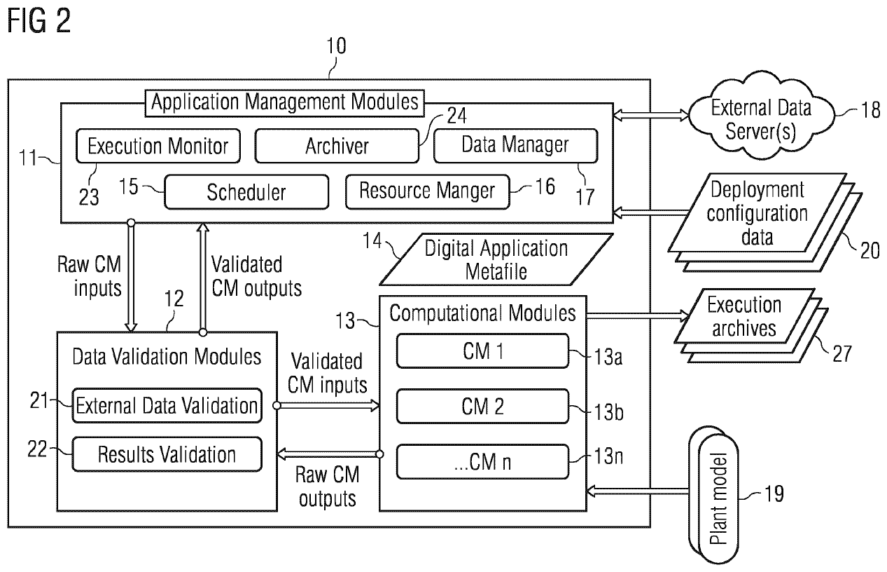

FIG. 2 shows a schematic illustration of a digital application platform architecture in accordance with embodiments of the present invention;

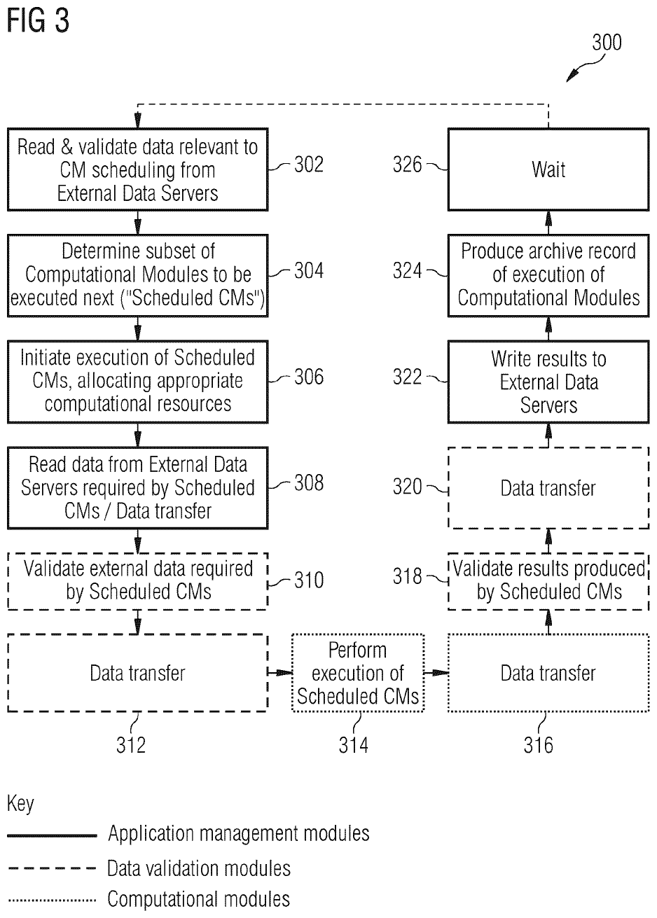

FIG. 3 shows a flowchart illustrating embodiments of the method of use of the digital application platform architecture in accordance with embodiments of the present invention;

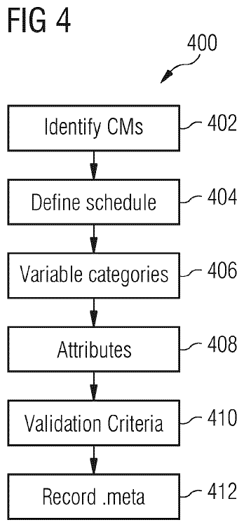

FIG. 4 shows a flowchart of a method of generating a digital application metafile in accordance with embodiments of the present invention;

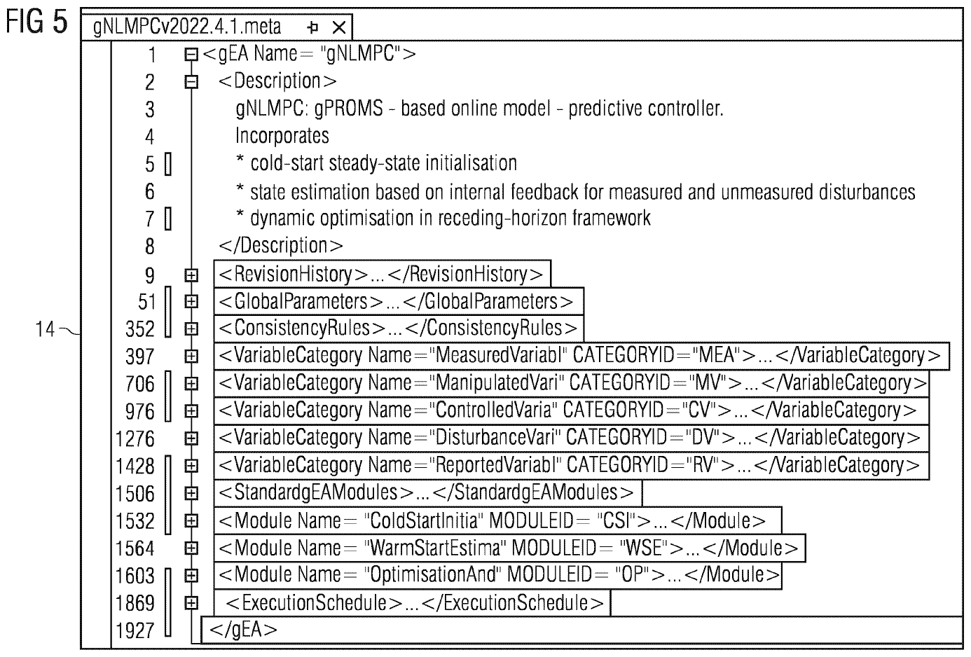

FIG. 5 shows an example digital application metafile for a real-time optimization digital application; and

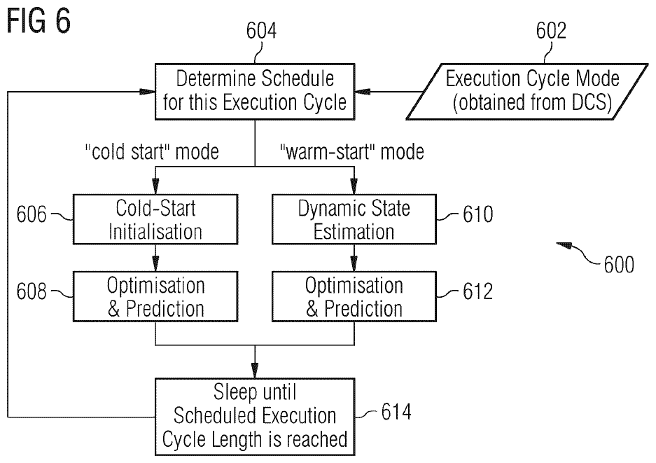

FIG. 6 shows a flowchart illustrating an example execution cycle for a digital application for non-linear model-predictive control (NLMPC).

### DETAILED DESCRIPTION

FIG. 1 illustrates the potential complexity of digital applications, which places stringent conditions on the testing and validation required to ensure that they can operate flawlessly, continuously and with little human intervention over extended periods of time. This complexity may also make digital applications difficult to maintain in the longer term, even after a successful initial development and deployment. The embodiments of the present invention deal with this complexity and diversity by providing a digital application platform architecture that functions within the industrial plant operational decision support system and implements a digital applications metafile enabling a variety of digital applications to be defined and implemented simply and easily. The platform architecture comprises a set of computational modules adapted to perform model-based computations relating to the plant. A scheduler module is included and adapted to orchestrate the execution of the computational modules. A resource manager module is provided and adapted to allocate computational resources to enable the execution of the computational modules. A data manager communicates with external data servers to acquire plant-related and other data, and to provide important results, including plant control settings. Data validation modules validate data received from the external data servers and results received from the set of computational modules. These deal with the issues surrounding complexity by ensuring that data used by the computational modules and their calculations are correct. A digital application metafile, accessible by all modules of the digital application, contains softcoded data governing the scheduling of, and data exchange between, the computational modules. The computational modules and the digital applications metafile are specific to the class of digital application being implemented. The softcoded data defines the information relevant to the class of digital application in terms of different categories of the variables and those variables' associated attributes, and defines rules governing the validity of all these data.

A digital application may be described as a well-defined task being executed under well-defined conditions, with well-defined inputs, leading to well-defined results while communicating with other IT software and hardware systems. For a real-time optimization (RTO) example, the digital application addresses a number of questions that arise during the operation of an industrial plant. These include: is the industrial plant currently operating at a steady state; how should inconsistencies in industrial plant data be dealt with; what happens if the industrial plant data is unavailable or invalid, and what should be done when this is the case; what should be done if an optimization calculation fails; and how is the industrial plant protected from unpredictable results produced by the optimization calculation? Such questions are answered by the approach of the embodiments of the present invention.

FIG. 2 is a schematic illustration of a digital application platform architecture in accordance with embodiments of the present invention. The digital application platform architecture 10 comprises a number of functional modules that may be considered to fall into three groups: application management modules 11, data validation modules 12 and computational modules 13, as well as a digital application metafile 14.

The set 13 of computational modules is specific to the class of digital application being implemented, with each computational module 13a, 13b . . . 13n performing a different computation, such as a model-based computation. For example, in the case of real-time optimization, as illustrated in FIG. 1, there would be three computational modules: steady-state detection 13a, data reconciliation 13b and steady-state optimization 13c. It should be understood that the number and nature of the computational modules 13a, 13b . . . 13n is flexible depending on the digital application.

The digital application metafile 14 is also specific to the class of digital application being implemented. It contains softcoded data governing the scheduling of, and data exchange between, the computational modules. The softcoded data defines the information relevant to the class of digital application in terms of categories of the variables required in the models used by the computational modules and the variables' associated attributes.

Unlike the example in FIG. 1, the scheduling of the execution of the computational modules 13a, 13b . . . 13n and the exchange of data between them is not hardcoded. Instead, in embodiments of the present invention, the scheduling of the execution of the computational modules 13a, 13b . . . 13n and the exchange of data between them is softcoded in the digital application metafile 14. Rather than hardcoding, where the behavior of a computer application is determined by the source code and cannot be changed by a user, softcoding allows this behavior to be determined entirely from information provided within the digital application metafile. Softcoding the digital application metafile 14 allows it to be managed automatically by two generalised software modules: the scheduler module 15 and the resource manager module 16. The scheduler module 15 orchestrates the execution of the computational modules 13a, 13b . . . 13n, determining and controlling when execution will occur. The resource manager module 16 allocates computational resources, such as computer cores or processors, to the execution of instances of the computational modules 13a, 13b . . . 13n. This allows for significantly more sophistication in digital application platform architecture 10 than the conventional strict sequence of calculations being executed in a cycle on a single processor. For example, the occurrence or timing of each computational modules' 13a, 13b . . . 13n execution may depend on the outcome of the execution of other computational modules 13a, 13b . . . 13n and/or events received from external data servers. In addition, one or multiple instances of each computational module 13a, 13b . . . 13n may be executed asynchronously in parallel, the occurrence, time and frequency of execution of such instances being determined based on scheduling rules softcoded in the digital application metafile 14. This allows the optimal use of multiple computer cores or processors, as determined by the resource manager module 16.

A further aspect of digital applications is the need for communication with various external software systems, such as the industrial plant historian, commercial databases (such as those with real-time materials pricing and availability information and product pricing information) and the industrial plant control system. To enable this functionality, the digital application platform architecture 10 incorporates a data manager 17 within the group of operational modules 11, which is adapted to communicate with a variety of external data servers 18. Communication with each type of external data server 18 is effected via a data client conforming to a standardized software interface and implementing a suitable industry-standard or proprietary communication protocol. These external data servers may typically comprise a range of software systems and associated data exchange protocols, including, but not limited to, the Data Access (DA), Historical Data Access (HDA), and Unified Architecture (UA) standards of Open Platform Communications (OPC), SQL and other databases, user dashboards, web services, and any other type of external data server offering an application programming interface (API) for retrieving or providing data relevant to the calculations of the digital application.

The deployment of a digital application to a specific industrial plant requires one or more mathematical models 19 of the plant which are used by the digital application's computational modules. These mathematical models are typically constructed and validated offline using appropriate modeling tools prior to their online deployment within the digital application.

Moreover, the deployment of a digital application to a specific plant requires deployment configuration data 20, supplied by the users in the form of structured files (e.g. XML or JSON). Such configuration information includes but is not limited to a) the identification of the variables within the mathematical models 19 that are relevant to the digital application, b) the categorisation of these variables according to the variable categories defined in the digital application metafile 14, and c) the provision of values for some or all of the attributes associated with each category (e.g., valid ranges for the values of variables measured via plant sensors, and for the rates of change of such values over time). It is also necessary to identify i) the specific external data servers with which the digital application will communicate (e.g. via an appropriate IP address for an OPC-based data server, or data source name (DSN) for a SQL database) and ii) the precise address of each data item (e.g. variable attribute) that will need to be communicated between the digital application and these external data servers (e.g. via an OPC tag name or a SQL database query).

A key determining factor for the resilience and robustness of digital applications is the quality of the data required by the computational modules 13a, 13b . . . 13n. In general, it is not possible to guarantee that data obtained from the external data servers 18 will always be correct or even available throughout the operation of the digital application. For example, data may be temporarily unavailable due to communication problems, and even when available, the actual data values may be incorrect due to sensor faults. For the digital application to continue to operate reliably in all circumstances, it needs to be able to identify faulty data values and take appropriate action in dealing with such faults. For example, the data value itself, the rate of change of data values over time or the relative values of multiple data items may indicate an issue. Replacing data values with previously obtained valid data values, adjusting them to within specified bounds, or being able to temporarily omit the execution of a computational module in a cycle may provide a solution to such issues. Within the digital application platform architecture, this is the responsibility of the external data validation module 21, which sits within the group of data validation modules 12. The criteria for validating data items and the actions to be taken in handing an invalid data item are also softcoded within the digital application metafile 14. This removes the need for the extensive amount of customized code usually required in hardcoded digital applications to ensure data integrity.

The data manager 17 is also responsible for communicating the results of the digital application to appropriate external data servers 18. For example, in the real-time optimization example above, the optimal control set points determined using the computational modules 13a, 13b . . . 13n need to be sent to the plant control system. Ensuring the integrity of such results is particularly important in the case of digital applications operating in a closed-loop mode. A separate results validation module 22, also provided in the group of validation modules 12, has the responsibility of performing a set of final validity checks on the results generated by the computational modules 13a, 13b . . . 13n. This acts as a final protection against any errors arising from unanticipated deficiencies at earlier stages of the input data validation and model-based computations. The rules and criteria for this validation are also softcoded into the digital application metafile.

In view of the complexity of most digital applications, it is also necessary to monitor their execution and take appropriate action in real time if this deviates from the expected performance. This is done by the execution monitor module 23. In addition, a record of performance to enable later troubleshooting of any problems that may arise during the operation of the digital application is kept by an archiver module 24, which, along with the execution monitor module 23, is within the group of application management modules 11. The execution monitor module 23 is adapted to monitor execution of the digital application in real time and to take appropriate action if it deviates from the expected performance or stops executing in its entirety. The archiver module 24 generates and stores a separate execution archive 27 recording the execution of each instance of a computational module 13a, 13b . . . 13n to a degree of detail that allows offline analysis and troubleshooting by qualified engineers at a later stage.

FIG. 3 is a flowchart illustrating embodiments of the method of use of the digital application platform architecture in accordance with embodiments of the present invention. In embodiments, the method 300 begins, at step 302, with the data manager 17 calling for data from the external data servers 18 that is required to determine the next scheduled computation (e.g. flags, set either manually by the industrial plant's operators or automatically by other parts of the plant's IT/automation system, requesting certain actions to take place) and the external data validation module 21 validating these data. By combining these data with the information in the digital application metafile 14, at step 304 the scheduler module 15 determines the subset of the computational modules 13a, 13b . . . 13n that need to be executed next (the “Scheduled CMs”). In some cases, these Scheduled CMs may actually contain multiple instances of the same Computational Module. This is the case, for example, when the same calculation needs to be applied separately to multiple identical equipment items or equipment trains within the industrial plant.

Execution of the Scheduled CMs is initiated at step 306, with the resource manager 16 allocating a suitable computational resource to each one of them. Steps 308-322 described below are performed for each of the Scheduled CMs as determined by the scheduler 15. These may be executed in sequence or in parallel, and their output may be used in determining further scheduling decisions. This information is part of the softcoded instructions in the Metafile 14.

Step 308 obtains all the data needed by the Scheduled CMs, by transferring data already obtained from external data servers 18 at step 302 and/or by reading additional such data from the external data servers. All such raw input data are passed by the data manager 17 to the external data validation module 21 which, at step 310, validates these raw data using the rules and criteria softcoded in the digital application metafile 14. At step 312, the validated data are passed to the Scheduled CMs to allow their execution at step 314. At step 316, the raw results from the Scheduled CMs are passed to the results validation module 22 which, at step 318, validates these results based on the rules and criteria softcoded in the digital application metafile 14. At step 320 the validated results are passed back to the data manager 17, where at step 322 they are transmitted to the external data servers 18. At step 324, the archiver module 24 creates an execution archive 27 containing a complete record of the execution of each Scheduled CM. The application then waits for the scheduler 15 to determine the next set of computational modules 13a, 13b . . . 13n to be executed; this may be at a fixed scheduled frequency, the result of an event such as a flag being written, or for example, a combination of both.

In embodiments, the method outlined in FIG. 3 relies on the information defined in the digital application metafile 14. In this example the digital application metafile 14 is in an XML format, and comprises metadata generated from the attributes of variables associated with the plant model 19 used as the basis of the computational modules 13a, 13b . . . 13n. The digital application metafile 14 stores data in a structured file format. This may be an XML, JSON or other suitable structured file format. This is illustrated further in FIG. 4, which is a flowchart of a method of generating a digital application metafile in accordance with embodiments of the present invention. In embodiments, the method 400 begins, at step 402, with identifying the set of the computational modules that are executable by the digital application. In the real-time optimization example of FIG. 1, this would include the steady-state detection module, the steady-state data reconciliation module and the steady-state optimization module. At step 404, the conditions under which one or multiple instances of a computational module are to be executed are defined in terms of data to be received from external data servers and/or to be generated by the execution of other computational modules. Next, the categories of variables that the digital application uses to perform computational tasks are defined at step 406. At step 408, the attributes associated with each defined category of variable are defined. Based on the defined attributes, at step 410, the criteria for external data validation, result validation, computing resource allocation and execution scheduling are determined. Finally, at step 412, the defined variable categories with their associated attributes, and the criteria for external data validation, result validation, computing resource allocation and execution scheduling associated with the digital application are stored as metadata within the digital application metafile.

FIG. 5 provides a high-level view of an example digital application metafile for a Non-Linear Model-Predictive Controller (NLMPC) digital application and is created in an XML format. At lines 51 to 351, parameters shared between different parts of the digital application (“<GlobalParameters>”) are listed, followed, at lines 352 to 396 by data consistency rules (“<ConsistencyRules>”).

Lines 397 to 1505 of the example digital application metafile in FIG. 5 specify the five variable categories that are considered by this digital application:
Measured variables (MEA);
Manipulated variables (MV
Controlled variables (CV);
Disturbance variables (DV);
Reported variables (RV).

The digital application metafile also defines the set of associated information items (“attributes”) associated with each variable category. A possible list of attributes for the five variable categories listed above is shown in Table 1:

TABLE 1
Variable Categories and Associated Attributes
Defined in an Example Digital Application Metafile
for Nonlinear Model-Predictive Control

| Measured | Manipulated | Controlled | Disturbance | Reported |
|---|---|---|---|---|
| Variable | Variable | Variable | Variable | Variable |
| Measured | Setpoint | Reference | Time | Estimated |
| Value | | Trajectory | Profile | Value |
| Standard | Change | Reference | Internal | |
| Deviation | Penalty | Trajectory | Feedback | |
| | | Violation | Flag | |
| | | Penalties | | |
| Standard | Optimization | Objective | Internal | |
| Deviation | Bounds | Function | Feedback | |
| Type | | Penalty | Associated | |
| | | | State | |
| | Active | Optimization | Internal | |
| | Flag | Bounds | Feedback | |
| | | | Gain | |
| | Critical | Active | Internal | |
| | Flag | Flag | Feedback | |
| | | | Nominal | |
| | | | Bias | |
| | | Critical | Internal | |
| | | Flag | Feedback | |
| | | | Nominal | |
| | | | Value Bias | |
| | | | Update Flag | |

It should be noted that a variable may belong simultaneously to more than one category, subject to compatibility rules whereupon membership of one category may require or preclude membership of another. For instance, in the NLMPC example considered here, membership of category MV requires also membership of category MEAS but precludes membership of categories CV or DV. This is illustrated further in Table 2 below which shows the category compatibility matrix specified within the digital application metafile 14:

TABLE 2
Compatibility of Variable Categories for Nonlinear Model-Predictive Control

| | Measured | Manipulated | Controlled | Disturbance | Reported |
|---|---|---|---|---|---|
| | Variable | Variable | Variable | Variable | Variable |
| Measured Variable | — | † | † | † | † |
| Manipulated Variable | ‡ | — | x | X | † |
| Controlled Variable | † | x | — | X | † |
| Disturbance Variable | † | x | x | — | † |
| Reported Variable | † | † | † | † | — |

Key:
‡: obligatory,
†: allowed,
x: not allowed

During the operation of a digital application, the values of certain variable attributes may be received from external data servers. The external data validation module 21 automatically performs a set of basic validity tests on such data values. For instance, in the example NLMPC application considered here, the measured value of a variable in the “Measured Variable” category will typically be requested from the industrial plant's distributed control system (DCS). The external data validation module 21 will then check whether this value was actually made available and is of the expected type (e.g. real, integer, logical or an enumerated string); and if it was, whether both it and its rate of change from previously obtained values lie within certain lower and upper bounds. These bounds are specified for each individual variable within the deployment configuration data 20 either explicitly or indirectly via reference to other data to be also obtained from external data servers. The deployment configuration data 20 also specify the action to be taken if an external data item is deemed to be unavailable or invalid. For example, an invalid value may be replaced by a valid value for the same data item, provided it is sufficiently recent; or be rendered valid by clipping to the nearest lower or upper bound.

The above basic validity tests are applied automatically in all cases. Additionally, the digital application metafile may specify more complex validation criteria for external data, including rules that can be used to check the mutual consistency of multiple data items. This corresponds to line 352 of the example metafile in FIG. 5. The rules may reference the value, specification status or validity status of any variable attribute. Table 3 below shows an example of a rule used by the external data validation module to determine whether the values of the three quantities mentioned in the bottom right cell are mutually consistent:

TABLE 3
Example of consistency rule defined in digital application
metafile to be used for external data validation

| | Applicable if variable | | Logical condition for |
|---|---|---|---|
| | in all of the following | Consistency rule | data to be deemed as |
| Rule Name | categories | being enforced | mutually consistent |
| MV Criticality | ManipulatedVariable | For a manipulated variable | (MeasuredValue.isValid |
| | MeasuredVariable | to be deemed to be critical, | AND ActiveFlag.value) |
| | | (a) its measurement must | OR NOT |
| | | be valid and (b) it must be | CriticalFlag.value |
| | | currently active | |

Lines 1532 to 1938 of the example digital application metafile of FIG. 5 specify the computational modules for the digital application, which in the case of NLMPC are Cold-Start Initialisation (CSI), Warm-Start Estimation (WSE) and Optimization and Prediction (OP).

Finally, lines 1869 to 1928 specify the rules to be used by the scheduler module 15 to determine the schedule on which the above computational modules should be executed. One such schedule is illustrated in FIG. 6, which is a flowchart illustrating an example execution cycle for a digital application for NLMPC. The precise schedule to be executed is determined by the Execution Cycle Mode which is an externally-obtained flag usually set manually by the plant's operator via the plant's distributed control system (DCS). There are two possible modes, namely a “cold-start” mode and a “warm-start” mode. The execution cycle 600 begins with, at step 602, the execution cycle mode being obtained from an external data server 18, typically the DCS. At step 604, the schedule for the next execution cycle is determined based on the selected mode. For the “cold-start” mode, a cold-start initialisation involving steady-state reconciliation of plant data is performed at step 606; this is followed by, at step 608, the main optimization and prediction calculation. For the “warm-start” mode, step 610 uses a dynamic state estimation calculation to determine the current state of the plant and estimate any unmeasured disturbances; this is followed by, at step 612, the optimization and prediction. At step 614, for both modes, the next scheduled action is to wait until the scheduled execution cycle length is reached, at which point the process returns to step 604, where the execution cycle schedule is determined.

The digital application platform architecture 10 described herein will have the same application management 11 and data validation 12 elements for each class of digital application 13 that is implemented. However, the digital application metafile 14, and the set 13 of computational modules 13a, 13b . . . 13n is specific to each class of digital application being implemented. For example, the digital application metafile 14, and the set 15 of computational modules 13a, 13b . . . 13n for real-time optimization will be different to the digital application metafile 14, and the set 15 of computational modules 13a, 13b . . . 13n for non-linear model-predictive control and so on. The overall behavior of the digital application is fully defined by the softcoded data in the digital application metafile 14. Therefore, the digital application platform architecture 10 allows a “plug and play” approach in that unique, specific digital application metafiles 14, and set 13 of computational modules 13a, 13b . . . 13n can be developed offline for each class of digital application to be implemented, and then used with application management 11 and data validation 12 elements. Furthermore, most computational modules 13a, 13b . . . 13n required by typical classes of digital applications can themselves be standardized as they correspond to a small number of standard forms of model-based computations such as steady-state or dynamic simulation or optimization, and state or parameter estimation.

Overall, this significantly reduces or eliminates the need for customized computer code, which facilitates the development of new types of digital applications and the maintenance of existing classes of digital applications. Any improvement in functionality of the digital applications platform architecture 10 will therefore be reflected immediately in all classes of digital applications that are built on it and implemented by it.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A digital application platform architecture for implementing a class of digital application within an industrial plant operational decision support system, comprising:
a set of computational modules configured to perform model-based computations relating to a plant;
a scheduler module configured to orchestrate an execution of the set of computational modules;
a resource manager module configured to allocate computational resources to enable the execution of the set of computational modules;
a data manager configured to communicate with external data servers providing plant-related data and plant control;
data validation modules configured to validate data received from the external data servers and to validate results computed by the set of computational modules; and
a digital application metafile, accessible by all components of the digital application, containing softcoded data governing a scheduling of the execution, and the data exchange between, the set of computational modules;
wherein the set of computational modules and the digital application metafile are specific to the class of digital application being implemented; and wherein the softcoded data defines the information relevant to the class of digital application in terms of categories of variables required in the models used by the set of computational modules and attributes associated with each category.

2. The digital application platform architecture as claimed in claim 1, wherein the data validation modules comprise:
an external data validation module configured to validate data obtained from the external data servers using criteria softcoded in the digital application metafile; and
a results validation module configured to validate results from each of the computational modules in the set using criteria softcoded in the digital application metafile.

3. The digital application platform architecture as claimed in 1, further comprising an execution monitor module configured to monitor execution of the digital application in real time and to take appropriate action if it deviates from an expected performance or stops executing in its entirety.

4. The digital application platform architecture as claimed in claim 1, further comprising an archiver module configured to maintain a record of a performance of the digital application, including the execution of each instance of each computational module.

5. The digital application platform architecture as claimed in claim 1, wherein one or more multiple instances of each computational module are executed asynchronously in parallel, an occurrence, a time and a frequency of execution of such instances being determined based on scheduling rules softcoded in the digital application metafile.

6. The digital application platform architecture as claimed in claim 1, wherein the data manager is configured to communicate using a plurality of data exchange protocols.

7. The digital application platform architecture as claimed in claim 1, wherein communication with each external data server is effected via a data client conforming to a software interface, wherein the data manager and the external data servers are configured to implement an industry-standard or proprietary communication protocol.

8. The digital application platform architecture as claimed in claim 1, further comprising input to the set of computational modules from one or more system models describing a behavior of the plant.

9. The digital application platform architecture as claimed in claim 7, wherein one or more computational modules within a set perform a different type of computation, each making use of a different system model.

10. The Digital application platform architecture as claimed in claim 1, wherein the metadata is stored within the digital application metafile in a structured file format.

11. A computer-implemented method of generating a digital application metafile for use in the digital application platform architecture of claim 1, the method comprising of:
a) identifying the set of the computational modules that are executable by the digital application;
b) defining conditions under which one or multiple instances of a computational module are to be executed based on data received from external data servers and/or generated by the execution of other computational modules;
c) defining the categories of variables that the digital application uses to perform computational tasks;
d) defining the compatibility rules between variable categories;
e) determining the associated attributes of each defined category of variable;
f) based on the determined attributes, determining criteria for external data validation, result validation, computing resource allocation and execution scheduling; and
storing the defined variable categories with their associated attributes, and the criteria for external data validation, result validation, computing resource allocation and execution scheduling as metadata associated with the digital application within the digital application metafile.

12. The computer-implemented method as claimed in claim 11, further comprising:
defining industrial plant parameters, data validation consistency rules, rules governing the inter-computational module communication and an execution schedule for the scheduler module; and
storing within the digital application metafile.

13. The computer-implemented method of claim 11, wherein the metadata is stored within the digital application metafile in a structured file format.
